(19) United States
(12) Patent Application Publication
(10) Pub. No.: US 2019/0162473 A1
(43) Pub. Date: May 30, 2019

(54) RADIANT HEATING PANEL FOR MELTING FURNACE

(71) Applicant: Fives North American Combustion, Inc., Cleveland, OH (US)

(72) Inventors: Douglas A. Clauss, Copley, OH (US); Thomas F. Robertson, Medina Township, OH (US)

(73) Assignee: Fives North American Combustion, Inc., Cleveland, OH (US)

(21) Appl. No.: 15/826,845

(22) Filed: Nov. 30, 2017

(51) Int. Cl. F27D 1/00; F27B 14/14; F27D 1/04

(52) U.S. Cl. CPC F27D 1/0006; F27B 2014/0843; F27D 1/04; F27B 14/14

(57) ABSTRACT

A radiant heating panel has an inner side surface configured to face into a combustion chamber and an outer side surface configured to face oppositely away from the combustion chamber. The panel has interconnected sections formed of ceramic material. The panel sections are elongated with adjacent longitudinal edge portions, and are joined and sealed together along the adjacent longitudinal edge portions. The outer side surface of the panel has a contour that undulates laterally across the panel sections.

### TECHNICAL FIELD

This technology includes a furnace for melting metal.

### BACKGROUND

A furnace for melting metal has a melting chamber with a discharge opening configured to discharge molten metal. The melting furnace may further have one or more burners that fire into a combustion chamber. An internal wall of the furnace may separate the melting chamber from the combustion chamber. In such a furnace the internal wall seals the combustion chamber from gas flow communication with the melting chamber. The inner wall also serves as a radiant heating panel with an inner side facing into the combustion chamber and an outer side facing into the melting chamber.

### SUMMARY

An apparatus is configured for use with a burner that fires into a combustion chamber. The apparatus includes a radiant heating panel having an inner side surface configured to face into the combustion chamber, and having an outer side surface configured to face oppositely away from the combustion chamber.

The radiant heating panel may include interconnected panel sections formed of ceramic material. The panel sections may be elongated, and may be joined and sealed together along adjacent longitudinal edge portions. The outer side surface of the panel may have a contour that undulates laterally across the panel sections.

In given examples, the apparatus includes a furnace having a melting chamber with a discharge opening configured to discharge molten metal. The furnace further has a combustion chamber that is sealed from gas flow communication with the melting chamber. The radiant heating panel has an inner side surface facing into the combustion chamber, and has an outer side surface facing into the melting chamber. The radiant heating panel may include interconnected panel sections formed of ceramic material, and the interconnected sections of the panel may include sections having a concave contour at the outer side surface.

### BRIEF DESCRIPTION OF THE DRAWINGS

FIG. 1 is schematic view of a furnace for melting metal.

FIG. 2 is a partial sectional view of a radiant heating panel for a furnace.

FIG. 3 is a sectional view of an alternative radiant heating panel for a furnace.

FIG. 4 is an enlarged partial view of parts shown in FIG. 3.

FIG. 5 is a perspective view of parts of a furnace.

FIG. 6 is an enlarged partial view of parts shown in FIG. 5.

FIG. 7 is a sectional view of another alternative radiant heating panel for a furnace.

FIG. 8 also is a sectional view of another alternative radiant heating panel for a furnace.

### DETAILED DESCRIPTION

The structures illustrated in the drawings include examples of the elements recited in the claims. The illustrated structures thus include examples of how a person of ordinary skill in the art can make and use the claimed invention. These examples are described to meet the enablement and best mode requirements of the patent statute without imposing limitations that are not recited in the claims. One or more of the elements of one embodiment may be used in combination with, or as a substitute for, one or more elements of another as needed for any particular implementation of the invention.

As shown schematically in FIG. 1, a melting furnace 10 has a wall structure 12 defining a melting chamber 15 and a combustion chamber 17. A door 20 is supported for sliding movement over a charge port 21 through which metal pieces are loaded into the melting chamber 15. Another door 24 is supported form movement over a discharge port 25 through which molten metal is drained from the melting chamber 15. A burner 26 is arranged to fire into the combustion chamber 17 to provide heat for melting the load. Products of combustion are directed outward from the combustion chamber 17 to a stack 28.

The combustion chamber 17 is sealed from gas flow communication with the melting chamber 15. This shields the molten metal from the products of combustion that are generated in the combustion chamber 17. The sealed condition is established in part by an internal furnace wall 40 that separates the melting chamber 15 from the combustion chamber 17.

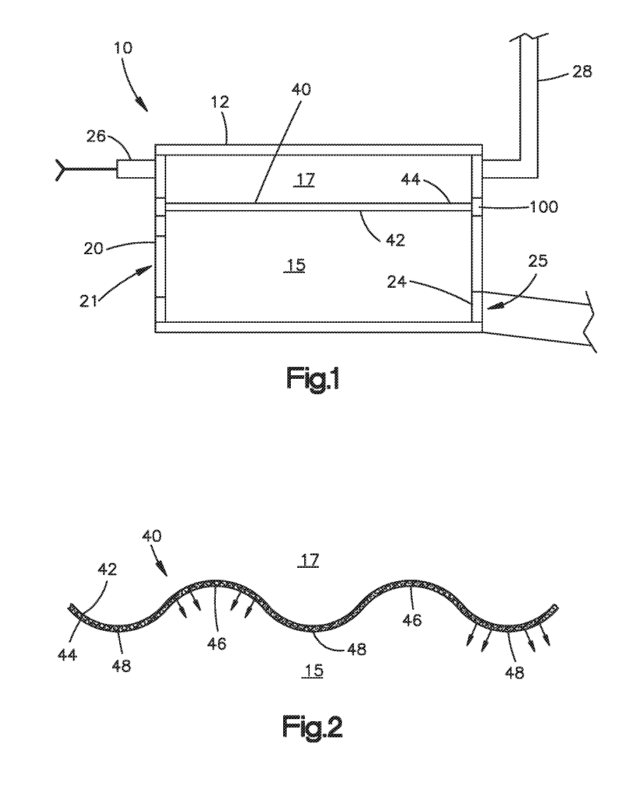

In addition to separating the two chambers 15 and 17, the internal wall 40 functions as a radiant heating panel for transferring thermal energy from the combustion chamber 17 to the load in the melting chamber 15. The internal wall 40 thus has an inner side surface 42 facing into the combustion chamber 17, and has an outer side surface 44 facing into melting chamber 15. As shown in greater detail in FIG. 2, the outer side surface 44 has an undulating contour providing alternating concave and convex areas 46 and 48 of the outer side surface 44. In this embodiment the concave and convex areas 46 and 48 have nonconcentric arcuate profiles. Each concave and convex area 46 and 48 directs radiant thermal energy into the melting chamber 15 in directions normal to the outer side surface 44, as indicated by the arrows shown in FIG. 2.

It may be preferable for the internal wall 40 to be formed of one or more ceramic materials for optimum heat transfer capability. Examples include silicon carbide and silicon nitride. However, an internal wall 40 of ceramic material that is thin enough to have adequate heat transfer capability might not have sufficient strength to span the periphery of the melting chamber 15 in a self-supporting configuration as shown in FIG. 1. For this reason the internal wall 40 may have the undulating cross-sectional profiles at both the inner and outer side surfaces 42 and 44, as shown in FIG. 2, such that the wall 40 as a whole is provided with a corrugated configuration for increased bending strength. The undulating profiles at the inner side surface 42 also serve to increase the surface area exposed to the products of combustion in the combustion chamber 17 for increased heat transfer through the wall 40.

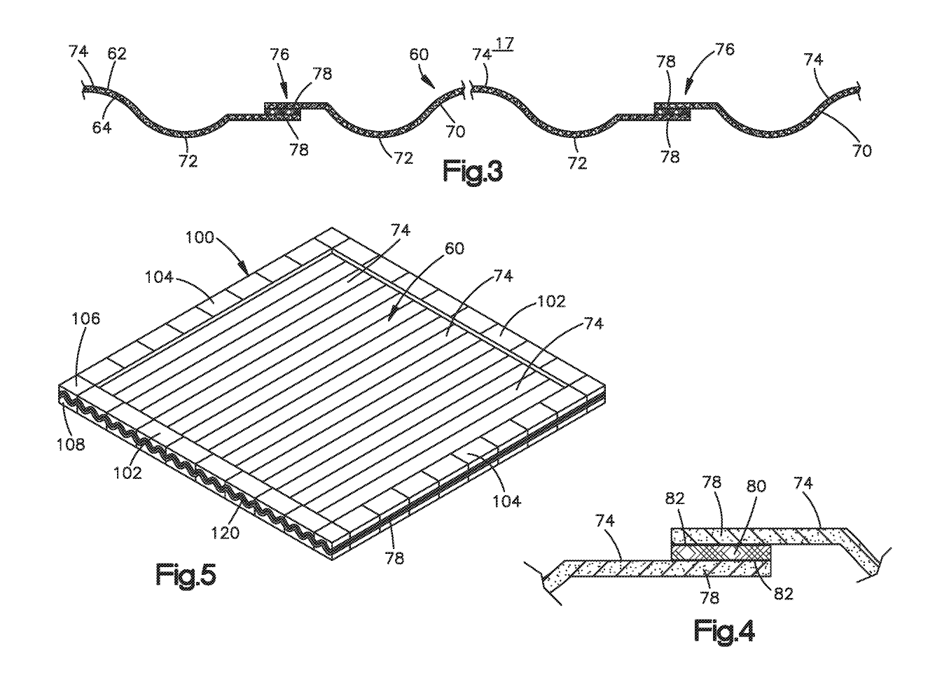

A variation of the internal wall 40 is shown partially in FIG. 3. In this embodiment, an internal wall 60 of the furnace 10 has an inner side surface 62 facing into the combustion chamber 17 and an outer side surface 64 facing into the melting chamber 15. Alternating concave and convex areas 70 and 72 at the outer side surface 64 have arcuate profiles facing into the melting chamber 15. Additionally, the internal wall 60 is assembled from extruded ceramic sections 74 that are interconnected at seams 76. The sections 74 of the wall 60 are elongated, and the seams 76 extend along and between adjacent longitudinal edge portions 78 of the sections 74. Each seam 76 preferably includes an elongated joint member 80 formed of a compressed fiber material. As shown in enlarged detail in FIG. 4, the joint members 80 are fixed in place by adhesive bonds 82. The joint members 80 and the bonds 82 together provide seals that block the flow of gas through the wall 60 between the adjacent sections 74.

As shown in FIG. 5, the internal wall 60 is provided with a peripheral retainer structure 100. The peripheral retainer structure 100 mounts the internal wall 60 within the surrounding portions of the furnace wall structure 12, as shown schematically in FIG. 1 with reference to the internal wall 40. As further shown in FIG. 5, the peripheral retainer structure 100 in the illustrated embodiment is rectangular with two pairs of parallel sides 102 and 104. The sides 102 and 104 are defined by upper and lower blocks 106 and 108 of refractory material.

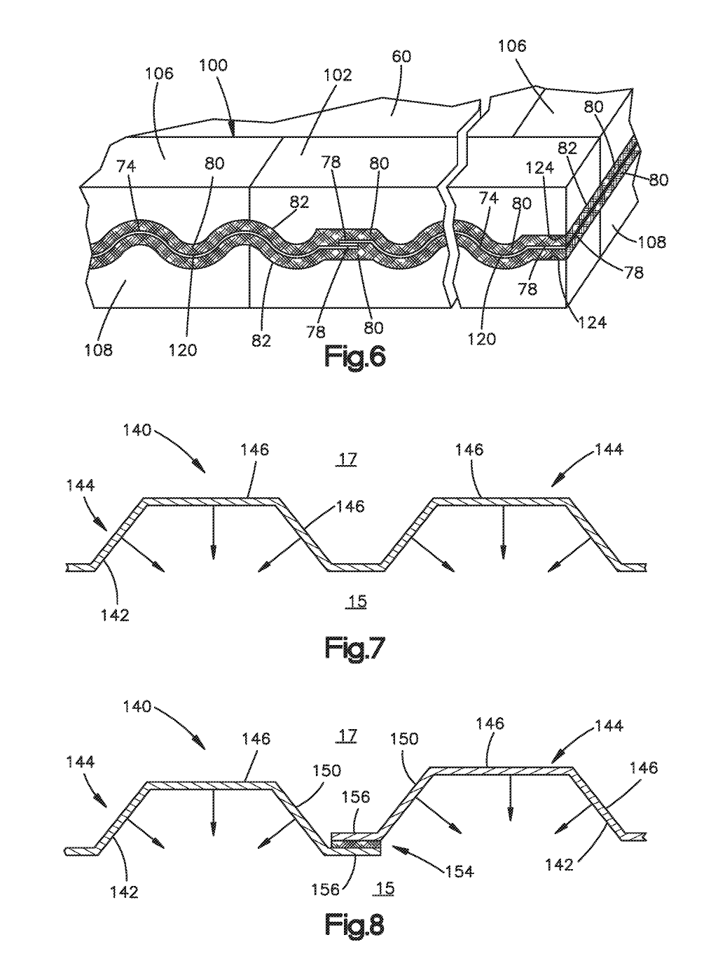

The sections 74 of the wall 60 reach end-to-end between the first sides 102. The sections 74 of the wall 60 thus have opposite ends 120 at the first sides 102. One section 74 of the wall 60 has a longitudinal edge portion 78 at one of the second sides 104. Another section 74 of the wall 60 has a longitudinal edge portion 78 at the other of the second sides 104. These peripheral portions 78 and 120 of the wall are captured between the upper and lower blocks 106 and 108 as shown in enlarged detail in FIG. 6. The blocks 106 and 108 have opposed surfaces 124 with contours corresponding to the contours at the peripheral portions 78 and 120 of the panel sections 74. The compressed fiber material of the joint members 84 is provided throughout the spaces between the panel sections 74 and the opposed block surfaces 124. The adhesive bonds 82 are likewise extended to provides seals for the wall 60 fully throughout the peripheral retainer structure 100.

Another alternative embodiment of a radiant inner wall 140 for the furnace 10 is shown in FIG. 7. Like the walls 40 and 60 of FIGS. 2 and 3, the wall 140 of FIG. 7 is formed of ceramic material, and has an inner side surface 142 with an undulating contour including multiple concave profiles 144. Each profile 144 directs radiant thermal energy into the melting chamber 15 in directions normal to the inner side surface 142. However, the concave contours at the profiles 144 are not arcuate, but instead have intersecting linear portions 146 reaching transversely across the profiles 144. As shown in FIG. 8, the wall 140 also may be formed of extruded sections 150 that are joined and sealed by seams 154 at their adjacent longitudinal edge portions 156, as described above with reference to the wall 60 of FIG. 3.

This written description sets for the best mode of carrying out the invention, and describes the invention so as to enable a person of ordinary skill in the art to make and use the invention, by presenting examples of the elements recited in the claims. The detailed descriptions of those elements do not impose limitations that are not recited in the claims, either literally or under the doctrine of equivalents.

1. An apparatus for use with a burner arranged to fire into a combustion chamber, comprising:
a radiant heating panel having an inner side surface configured to face into the combustion chamber, and having an outer side surface configured to face oppositely away from the combustion chamber;
wherein the radiant heating panel includes interconnected panel sections formed of material comprising ceramic material.

2. An apparatus as defined in claim 1 wherein the material comprises silicon carbide.

3. An apparatus as defined in claim 1 wherein the material comprises silicon nitride.

4. An apparatus as defined in claim 1 wherein the interconnected panel sections include elongated sections providing the outer side surface with a contour that undulates laterally across the sections.

5. An apparatus as defined in claim 4 wherein the elongated sections include sections having concave contours at the outer side surface, and the concave contours have nonconcentric arcuate profiles.

6. An apparatus as defined in claim 4 wherein the elongated sections include sections having concave contours at the outer side surface and the concave contours have intersecting portions with linear profiles reaching laterally across the sections.

7. An apparatus as defined in claim 4 wherein elongated sections further provide the inner side surface with a contour that undulates laterally across the sections.

8. An apparatus as defined in claim 1 wherein the interconnected panel sections include elongated sections having laterally adjacent longitudinal edge portions, and the radiant heating panel further includes elongated joint members interposed between the laterally adjacent longitudinal edge portions.

9. An apparatus as defined in claim 8 further comprising adhesive bonds between fixing the joint members to the laterally adjacent longitudinal edge portions of the panel sections to define seals blocking gas flow through the panel between the sections.

10. An apparatus as defined in claim 8 wherein the joint member is formed of compressed fiber material.

11. An apparatus for use with a burner arranged to fire into a combustion chamber, comprising:
a radiant heating panel having an inner side surface configured to face into the combustion chamber, and having an outer side surface configured to face oppositely away from the combustion chamber;
wherein the radiant heating panel includes panel sections that are elongated with adjacent longitudinal edge portions, the panel sections are joined and sealed together along the adjacent longitudinal edge portions, and the outer side surface has a contour that undulates laterally across the panel sections.

12. An apparatus as defined in claim 11 wherein the inner side surface also has a contour that undulates laterally across the panel sections.

13. An apparatus as defined in claim 11 wherein the panel sections include sections having concave contours at the outer side surface, and the concave contours have nonconcentric arcuate profiles.

14. An apparatus as defined in claim 11 wherein the panel sections include sections having concave contours at the outer side surface, and the concave contours have intersecting portions with linear profiles reaching laterally across the sections.

15. An apparatus as defined in claim 11 wherein the interconnected panel sections include elongated sections having laterally adjacent longitudinal edge portions, and the radiant heating panel further includes elongated joint members interposed between the laterally adjacent longitudinal edge portions.

16. An apparatus as defined in claim 15 wherein the joint members are adhered to the laterally adjacent longitudinal edge portions of the panel sections to define seals blocking gas flow through the panel between the sections.

17. An apparatus as defined in claim 15 wherein the joint members are formed of compressed fiber material.
